(19) United States
(12) Patent Application Publication
(10) Pub. No.: US 2010/0145130 A1
(43) Pub. Date: Jun. 10, 2010

(54) Treatment Method for Stabilizing Selenium in Coal Combustion Ash

(76) Inventor: Thomas P. McCullough, Indianapolis, IN (US)

Correspondence Address: BARNES & THORNBURG LLP, 11 SOUTH MERIDIAN, INDIANAPOLIS, IN, 46204, US

(21) Appl. No.: 12/633,360

(22) Filed: Dec. 8, 2009

Related U.S. Application Data
(60) Provisional application No. 61/121,016, filed on Dec. 9, 2008.

(51) Int. Cl. A62D 3/33

(52) U.S. Cl. 588/315

(57) ABSTRACT

Treatment of heavy metal-containing waste products including selenium- and arsenic-containing waste products, from flue gas desulfurization (FGD) treatment systems utilizing alternative alkali materials such as soda ash (Na₂CO₃), nahcolite (NaHCO₃), trona (Na₂CO₃/NaHCO₃), sodium sulfite (Na₂SO₃), sodium hydroxide (NaOH), and the like in various combinations.

### CROSS-REFERENCE TO RELATED APPLICATIONS

This application claims the benefit under 35 U.S.C. §119 (e) of the Dec. 9, 2008 filing date of U.S. Ser. No. 61/121,016. The disclosure of U.S. Ser. No. 61/121,016 is incorporated herein by reference.

### FIELD OF INVENTION

This invention related to the treatment of selenium contained within coal combustion ash and coal combustion byproducts from FGD, particularly those FGD systems that utilize soda ash (Na₂CO₃), nahcolite (NaHCO₃), trona (Na₂CO₃/NaHCO₃), and others in various combinations.

### BACKGROUND OF INVENTION

Sulfur dioxide (SO₂) emissions from the combustion of coal in coal-fired systems require removal from exhaust gases (sometimes referred to as flue gases) prior to release of the gases into the environment. Many materials have been employed to treat the flue gases. The physical nature of these materials varies from wet scrubbing to injection of dry powdered materials and is dependent upon the overall pollution control process system employed.

SO₂ is an acid gas and thus the typical slurries or other materials used to remove (“scrub”) the SO₂ from the flue gases are alkaline. Therefore the majority of wet scrubber systems utilize aqueous slurries of lime-based reagents (e.g. calcium sulfite) or limestone to neutralize the sulfurous and/or sulfuric acids produced from the dissolution and subsequent oxidation of flue gas in scrubbing systems.

The reaction taking place in wet scrubbing using a CaCO₃ (limestone) slurry produces CaSO₃ (calcium sulfite) and can be expressed as:

CaCO₃ (solid)+SO₂ (gas)→CaSO₃ (solid)+CO₂ (gas)

Other wet scrubbing systems use lime-based slurries to remove SO₂ from the flue gas:

Ca(OH)₂ (solid)+SO₂ (gas)→CaSO₃ (solid)+H₂O (liquid)

When using any of the above mentioned wet scrubbing systems that are based upon limestone slurries or lime-based reagents, large volumes of waste product are produced and must be hauled away for disposal. Such practice is common among power plants located in areas where landfill space is abundant or is a cost-effective disposal alternative.

In densely populated areas, or where land disposal is cost prohibitive or prohibited by regulation, some operators of wet FGD scrubbing systems add an additional step to further oxidize the CaSO₃ (calcium sulfite) to produce marketable CaSO₄.2H₂O (gypsum):

CaSO₃ (solid)+ 1/20O₂ (gas)+2H₂O (liquid)→CaSO₄.2H₂O (solid)

Recently, other alkali materials in lieu of lime-based reagents and limestone which offer flexibility and versatility in the operation, maintenance and waste disposal requirements of FGD scrubber systems have gain acceptance. These other materials are typically more expensive than limestone and are more often used:

1. where the volume of waste gas to be treated is small (compared to those from large power plants);

2. where other factors such as transportation cost of the alkali material is economical;

3. where required or necessitated by local or regional regulatory constraints; or

4. where any combination of these and other economic, technical, or regulatory issues make this alternative economically and environmentally viable.

Common alternative alkali materials used in lieu of lime-based reagents or limestone include soda ash (Na₂CO₃), nahcolite (NaHCO₃), trona (Na₂CO₃.NaHCO₃.2H₂O), and others in various combinations.

Trona, sometimes referred to as sodium sesquicarbonate (Na₂CO₃/NaHCO₃), is a natural mineral and is receiving more widespread use in dry FGD systems. Dry powdered trona is blown into the air duct containing coal combustion products (CCP) and acidic flue gases. The gases react with the trona to form by-products. The CCPs, by-products, and any excess trona are removed from the air stream using an electrostatic precipitator portion of the FGD system, conditioned with water for dust suppression (approximately 5:1 ratio trona ash to water) prior to disposal into a landfill.

PCT/EP2006/065097, Maziuk describes the chemical reaction of the trona with SO₂, which unlike sodium bicarbonate, melts at elevated temperatures. According to Maziuk '097, Trona (sodium sesquicarbonate) undergoes rapid calcination of contained sodium bicarbonate to sodium carbonate when heated at or above 275° F. Maziuk '097 theorizes that the “popcorn like” decomposition creates a large and reactive surface by bringing unreacted sodium carbonate to the particle surface for SO₂ neutralization. The byproduct of the reaction is sodium sulfate and is collected with fly ash. The chemical reaction of the trona with the SO₂ is represented below:

2[Na₂CO₃.NaHCO₃.2H₂O]→3Na₂CO₃+5H₂O +CO₂

Na₂CO₃+SO₂→Na₂SO₃+CO₂

Na₂SO₃+½O₂→Na₂SO₄

Other reactions with trona when injected into coal fired plant flue gas, include reactions with hydrochloric acid and SO₂ according to the following:

[Na₂CO₃.NaHCO₃.2H₂O]+3HCl →3NaCl+4H₂O+2CO₂

2[Na₂CO₃.NaHCO₃.2H₂O]+3SO₂→3Na₂SO₃+4CO₂+5H₂O

Na₂SO₃+½O₂→Na₂SO₄

The solid reaction products of the trona and the SO₂ (primarily sodium sulfate) and unreacted soda ash are then collected in an electrostatic precipitator, or other particulate collection device. The total desulfurization is preferably at least about 70%, more preferably at least about 80%, and most preferably at least about 90%. The trona is maintained in contact with the flue gas for a time sufficient to react a portion of the trona with a portion of the SO₃ to reduce the concentration of the SO₃ in the flue gas stream. SO₃ is typically more reactive with the sorbent than SO₂, so the trona would remove the SO₃ first.

Therefore, wastes and byproducts generated from FGD systems that predominately use trona in their FGD systems contain not only fly ash particles coated and intermixed with sodium sulfite/sulfate, and unreacted sorbent, but also contain various metals and other chemical attributes that may pose an environmental threat if the waste is placed in a landfill or used for beneficial re-use (such as coal ash placement).

In particular, selenium (Se) and arsenic (As) in an untreated trona-based FGD waste are usually above the regulatory limits and must be treated prior to land disposal or beneficial re-use. For example, the maximum acceptable leachate concentration for selenium into a RCRA Subtitle D landfill is one (1) mg/L. Selenium is a difficult metal to treat because selenium (Se) exhibits a variety of oxidation states. For example, in the alkaline environments under slightly oxidizing conditions, the selenate (Se⁺⁴, SeO₄⁻²) ion predominates. Conversely, in acidic environments that are still oxidizing, the selenite (Se⁺³, SeO₃) ion predominates. Selenate is significantly mobile in soils with little adsorption of the selenate ion over a pH range of 5.5-9.0. Therefore, selenium mobility is favored in oxidizing environments under alkaline conditions. Therefore the concentration and form of Se is governed by pH, redox, and matrix composition (e.g. soil, ash) and makes short term and long term treatment difficult in various environments, but particularly difficult for FGD wastes at elevated pH with excess trona (Na₂CO₃.NaHCO₃.2H₂O).

Another method to mitigate the above described environmental threat in FGD systems that predominately use alternative alkali materials (for example, soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these) is to treat the flue gas prior to treating the gas with these alternative alkali materials. For example, selenium (Se) in an untreated trona-based FGD waste is usually above the regulatory limits. Therefore, it may be beneficial to treat selenium-containing flue gas by chemical reagents, including but not limited to, calcium carbonate, magnesium carbonate, magnesium sulfite, ground glass blast furnace slag (GGBFS), lime kiln dust, cement kiln dust, and the like, individually, sequentially, or in mixtures thereof prior to treating the gas with the above-described alkali materials. It is believed that injection of calcium carbonate, magnesium carbonate, magnesium sulfite, ground glass blast furnace slag (GGBFS), lime kiln dust, cement kiln dust, and the like, individually, sequentially, or in mixtures thereof into the flue gas stream upstream from the above-described alkali materials provides for exposure of the heavy metals, such as selenium, arsenic and the like, to the calcium carbonate, magnesium carbonate, magnesium sulfite, ground glass blast furnace slag (GGBFS), lime kiln dust, cement kiln dust, and the like, individually, sequentially, or mixtures thereof, in the flue gas stream prior to exposure of the heavy metals to highly active sodium species resulting from the injection of soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these. This is believed to inhibit the formation of soluble sodium-heavy metal complexes, compounds, and the like, resulting from the introduction of soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these before or contemporaneous with the calcium carbonate, magnesium carbonate, magnesium sulfite, ground glass blast furnace slag (GGBFS), lime kiln dust, cement kiln dust, and the like, individually, sequentially, or mixtures thereof.

### Experimental Results:

A mixture of 5 grams of FeS and 15 g of water was added to 100 grams of unconditioned (dry) trona ash and mixed for five minutes and submitted to a laboratory for analysis. A summary of the results is shown in Table 1.

TABLE 1
TREATMENT OF TRONA ASH WITH FERROUS SULFIDE AND
CALCIUM POLYSULFIDE (all data in mg/L)

| | | | | Trona Ash | |
|---|---|---|---|---|---|
| | Untreated | | | treated with | |
| | Trona Ash | | | FeS | CaSx |
| EPA Test Method⁽¹⁾ | SPLP | Totals | TCLP | SPLP | SPLP |
| Antimony | 0.05 | 7.8 | NA⁽²⁾ | BDL⁽³⁾ | NA |
| Arsenic | 1.77 | 36 | <1 | 0.79 | NA |
| Barium | 0.16 | 946 | <20 | BDL | NA |
| Beryllium | <0.001 | 15.7 | NA | BDL | NA |
| Boron | 1.11 | 632 | NA | 0.41 | NA |
| Cadmium | <0.01 | 0.96 | <0.2 | BDL | NA |
| Chromium | 0.09 | 25 | <1 | BDL | NA |
| Cobalt | <0.001 | 23 | NA | BDL | NA |
| Copper | 0.01 | 62 | NA | BDL | NA |
| Lead | 0.01 | 7.8 | NA | BDL | NA |
| Mercury | 0.003 | 1.83 | <0.04 | BDL | NA |
| Manganese | <0.01 | 97 | NA | BDL | NA |
| Molybdenum | 0.33 | 7.8 | <1 | 0.15 | NA |
| Nickel | <0.01 | 38 | NA | BDL | NA |
| Selenium | 1.25 | 12 | 1.0 | 0.59 | 0.66 |
| Silver | 0.01 | 3.8 | <1.0 | BDL | NA |
| Sodium | 5390 | 56700 | NA | 3400 | NA |
| Thallium | 0.001 | 2.7 | NA | BDL | NA |
| Vanadium | 0.91 | 56 | NA | 0.24 | NA |
| Zinc | 0.02 | NA | NA | BDL | NA |
| Initial pH | 11.1 | 11.1 | 11.1 | 11.9 | 11.2 |
| Final pH | | | | 10.9 | 7.4 |

⁽¹⁾SPLP - United States EPA Method SW846-1312 (Synthetic Precipitation Leaching Procedure); Totals - United States EPA Method SW846-3052 (Microwave Assisted Acid Digestion of Siliceous and Organically Based Matrices); TCLP - United States EPA Method SW846-1311 (Toxicity Characteristic Leaching Procedure).
⁽²⁾NA—not available or measured
⁽³⁾BDL—below detection limit

What is claimed is:

1. A method for the chemical stabilization of selenium contained within a coal combustion product or byproduct from a flue gas desulfurization (FGD) treatment process comprising mixing said coal combustion product or byproduct with an insoluble or soluble sulfide compound to stabilize the leachable selenium in said coal combustion product or byproduct and then treating the thus-treated coal combustion product or byproduct with soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these.

2. The method according to claim 1, wherein the insoluble or soluble sulfide compound is added directly to the coal combustion product or byproduct prior to further conditioning or final disposal of the coal combustion product or byproduct to land or a landfill.

3. The method according to claim 2, wherein the insoluble or soluble sulfide compound is selected from sodium sulfide, calcium polysulfide, ferrous sulfide, and mixtures of these.

4. The method according to claim 1, wherein the insoluble or soluble sulfide compound is added to conditioning water and the conditioning water treated with the insoluble or soluble sulfide compound is then mixed with the coal combustion product or byproduct prior to further conditioning or final disposal of the coal combustion product or byproduct to land or a landfill.

5. The method according to claim 4, wherein the insoluble or soluble sulfide compound is selected from sodium sulfide, calcium polysulfide, ferrous sulfide, and mixtures of these.

6. A method of treating heavy metal-containing flue gas comprising exposing the heavy metal-containing flue gas to calcium carbonate, magnesium carbonate, magnesium sulfite, ground glass blast furnace slag (GGBFS), lime kiln dust, cement kiln dust, and mixtures of these, and then exposing the thus-exposed heavy metal-containing flue gas to soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these.

7. A method for treating heavy metal contained within a coal combustion product or byproduct from a flue gas desulfurization (FGD) treatment process comprising exposing said coal combustion product or byproduct to an insoluble or soluble sulfide compound and then exposing the thus-treated coal combustion product or byproduct to soda ash (Na₂CO₃), nahcolite (NaHCO₃), trona (Na₂CO₃.NaHCO₃.2H₂O), sodium sulfite (Na₂SO₃), sodium hydroxide (NaOH) or mixtures of these.

8. The method according to claim 7, wherein the insoluble or soluble sulfide compound is added directly to the coal combustion product or byproduct prior to further conditioning or final disposal of the coal combustion product or byproduct to land or a landfill.

9. The method according to claim 8, wherein the insoluble or soluble sulfide compound is selected from sodium sulfide, calcium polysulfide, ferrous sulfide, and mixtures of these.

10. The method according to claim 7, wherein the insoluble or soluble sulfide compound is added to conditioning water and the coal combustion product or byproduct is then exposed to the conditioning water treated with the insoluble or soluble sulfide compound prior to further conditioning or final disposal of the thus-treated coal combustion product or byproduct to land or a landfill.

11. The method according to claim 10, wherein the insoluble or soluble sulfide compound is selected from sodium sulfide, calcium polysulfide, ferrous sulfide, and mixtures of these.
